(19) United States
(12) Patent Application Publication
(10) Pub. No.: US 2014/0223711 A1
(43) Pub. Date: Aug. 14, 2014

(54) Machine Tool

(71) Applicant: Mauser-Werke Oberndorf Maschinenbau GmbH, Oberndorf (DE)

(72) Inventors: Roland Feichtl, Wien (AT); Gerold Schwarzwaelder, Dietingen (DE)

(21) Appl. No.: 14/343,654

(22) PCT Filed: Sep. 17, 2012
(86) PCT No.: PCT/EP2012/068239

§ 371 Date: Mar. 7, 2014

(30) Foreign Application Priority Data
Sep. 16, 2011 (DE) 10 2011 053 729.5

(51) Int. Cl. B23Q 39/02

(52) U.S. Cl. CPC B23Q 39/021
USPC 29/56.5

(57) ABSTRACT

The invention discloses a machine tool for machining workpieces comprising a frame by means of which a working space is delimited and by which accommodating compartments are formed in which a first machining module and a workpiece carrier are retained, wherein predominantly the workpiece carrier is movable along at least one guide, especially an X and/or Y and/or Z guide, for machining the workpieces. The first machining module of the machine tool includes at least five tool spindles which, or rather the tools of which, simultaneously can be engaged in a respective one of the workpieces.

### BACKGROUND OF THE INVENTION

1. Field of the Invention

The invention relates to a machine tool according to the preamble of claim 1.

2. Description of Related Art

The European patent specification EP 2 121 237 B1 discloses a machine tool of this type in inverse construction. It comprises a machine base having a frame by the grid structure of which accommodating compartments are formed which are provided for storing a plurality of tool spindle heads and a workpiece carrier. The workpiece carrier is movable along au X-Y-Z guide according to an inverse concept. For loading and unloading the workpiece carrier a workpiece feeding means extending on the side of the machine tool is provided.

This machine tool shows the drawback that high investment costs are involved required output of workpieces.

### SUMMARY OF THE INVENTION

The object of the present invention therefore is to provide a machine tool that needs lower investment costs for a required output of workpieces.

This object is achieved by a machine tool in accordance with claim 1.

A machine tool of this type for machining workpieces comprises a machine tool frame by which a working space is limited. Furthermore by means of the frame at least one first machining module and a workpiece carrier are retained. According to the concept of the inverse machine tool, for machining predominantly the workpiece carrier is movable along at least one guide, especially a Z guide or a Y guide or an X guide. In accordance with the invention, the first machining module of the machine tool has at least five tool spindles which—or rather the tools of which—can be simultaneously engaged in a respective one of the workpieces.

Vis-à-vis conventional machine tools of the state of the art, which have allowed for a simultaneous machining of only four workpieces so far, in this way more workpieces can be simultaneously machined, whereby a machine tool is provided that has lower investment costs for a given or required output of workpieces. The tools are preferably equal or similar so that the same machining can be simultaneously performed at five workpieces. Of particular preference, the workpiece carrier is movable along an X-Y-Z guide. In addition, it is possible that the workpiece carrier is movable along an X, X-Y or X-Y-Z guide. According to the concept of the inverse machine tool, the major movement toward machining and during machining is carried out by the workpiece carrier.

In an advantageous variant of the machine tool the first machining module has at least six tool spindles which—or rather the tools of which—can be simultaneously engaged in a respective one of the workpieces. In this way even more workpieces can be simultaneously machined, which entails further increase in the output.

In an especially advantageous further development of the machine tool, the latter includes a second machining module comprising—depending on the variant—at least five or at least six tool spindles which—or rather the tools of which—can be simultaneously engaged in a respective one of the workpieces.

In this context, it is of particular advantage that a machine tool in which machining conventionally would be performed by the second machining module can be saved and both machining operations can be performed in only one machine tool. in this manner, investment costs can be further reduced. In an even more advantageous development of the machine tool, the latter includes a plurality of machining modules having, depending on the chosen variant, at least five or at least six tool spindles which—or rather the tools of which—can be simultaneously engaged in a respective one of the workpieces.

In an advantageous development of the machine tool, the latter is configured so that the tools of the first machining module and the tools of the second or any of the further machining modules can be simultaneously engaged in the workpieces. This offers the advantage that at the same time two different machining operations of the workpieces can be performed so that machining time can be further saved. Alternatively or in addition, the machining operations can also be performed sequentially so that the tools of the second or any of the further machining modules can be engaged in the workpieces after the tools of the first machining module.

The machine tool according to the invention is especially suited for machining connecting rods. Preferably a pre-machining operation is performed by the first machining module, for example drilling or grinding connecting rod top ends, and a screw-hole machining operation of the connecting rods is performed by the second machining module.

In general, an arrangement of the tool spindles of the machining modules in a line is preferred. The spatial design of the line corresponds to an in-line arrangement of the workpieces on the workpiece carrier and especially preferred is aligned transversely to the feed direction Z in linear and horizontal or linear and vertical direction. A machining module basically can also have plural machining stations and steps, respectively. In this case each machining station preferably has its our line of tool spindles resulting in plural lines of tool spindles for each machining module. Said plural lines are preferably juxtaposed or superimposed in a compact manner on the machining module so as to optimally utilize the space offered in the working chamber.

In order to be able to efficiently load and unload the workpiece carrier the machine tool preferably includes a workpiece carrier inserting means having a carrying member for carrying a plurality of workpieces and extending approximately in parallel to a lower side of the machine tool. Compared to conventional workpiece carrier inserting means, an increased space is resulting, as building space extending on the side of the machine tool can be saved. The building height of the machine tool is only slightly increased, on the other hand, by the workpiece carrier inserting means arranged in parallel to the lower side of the machine tool.

The feeding of workpieces to be machined and the removal of the machined workpieces can be further improved, if the machine tool in a preferred further development includes a workpiece conveying means for loading and unloading the carrying member of the workpiece carrier inserting means. The workpiece conveying means preferably extends substantially on the side of the machine tool, in parallel to one of the side walls thereof and in parallel to the workpiece carrier inserting means, respectively. The workpiece conveying means preferably exhibits a feeder by which the workpieces to be machined are transferred to a cross conveyor. The latter conveys the workpieces to the carrying member of the workpiece carrier inserting means arranged beneath the machine tool which is loaded with an amount of workpieces corresponding to the number of spindles of the first machining module. The carrying member moves into the working space and subsequently transfers the workpieces to the workpiece carrier on which they are clamped for machining as specified. Upon completion of the machining operation or the machining operations, the carrying member takes over the machined workpieces and re-transfers them to the cross conveyor which in turn transfers them to a discharger.

Especially preferred, the carrying member has a plurality of holders for workpieces to be supplied to the workpiece carrier and a plurality of holders for workpieces to be removed from the workpiece carrier, wherein the respective holders can be brought into the respective transfer position by swiveling the carrying member. The workpiece carrier inserting means has a particularly simple design, if the holders are arranged on side faces offset against each other of the carrying member pivoting about an A axis parallel to the X axis. Said carrying member is preferably movable into the working space or out of the working space along a guide through a functional compartment of the frame of the machine tool.

These and other features and advantages of the invention will become apparent to those skilled in the art from the following description and the accompanying drawing. It should be understood, however, that the detailed, description and specific examples, while indicating a preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Hereinafter a preferred embodiment of the invention is illustrated in detail by way of 10 drawings.

FIG. 1 shows the embodiment of a machine tool for a general survey in a first isometric overall view;

FIG. 2 illustrates the same machine tool according to a preferred embodiment in a similar isometric view;

FIG. 3 illustrates the machine tool according to a preferred embodiment in a top view;

FIG. 4 illustrates a view of the machine tool according to a preferred embodiment along the X axis thereof;

FIG. 5 illustrates the machining of the connecting rods of a preferred embodiment;

FIG. 6 shows an isometric partial view of the machine tool according to a preferred embodiment;

FIG. 7 shows an isometric partial view similar to FIG. 6 but in deviation therefrom with better view of the tool spindles;

FIG. 8 illustrates an isometric partial view of the machine tool according to a preferred embodiment, viewed obliquely from the bottom; and

FIGS. 9 and 10 show two further isometric partial views of the working space along with the design of the frame and the drives.

### DETAILED DESCRIPTION OF THE DRAWINGS

For a more detailed description especially of the configuration, the functioning and the advantages of an inverse machine concept of the machine tool explained in the following (hereinafter 1) and especially of its rigid frame (2), the functional compartments formed therein, the accesses (18) accommodated therein, machining modules (43, 47) including tool spindles (46, 50), the sleeve (52) of a workpiece carrier (12), the workpiece carrier (12) and the coolant/lubricant supply (30) the content of the applicant's European patent EP 2 121 237 B1 is referred to in this context.

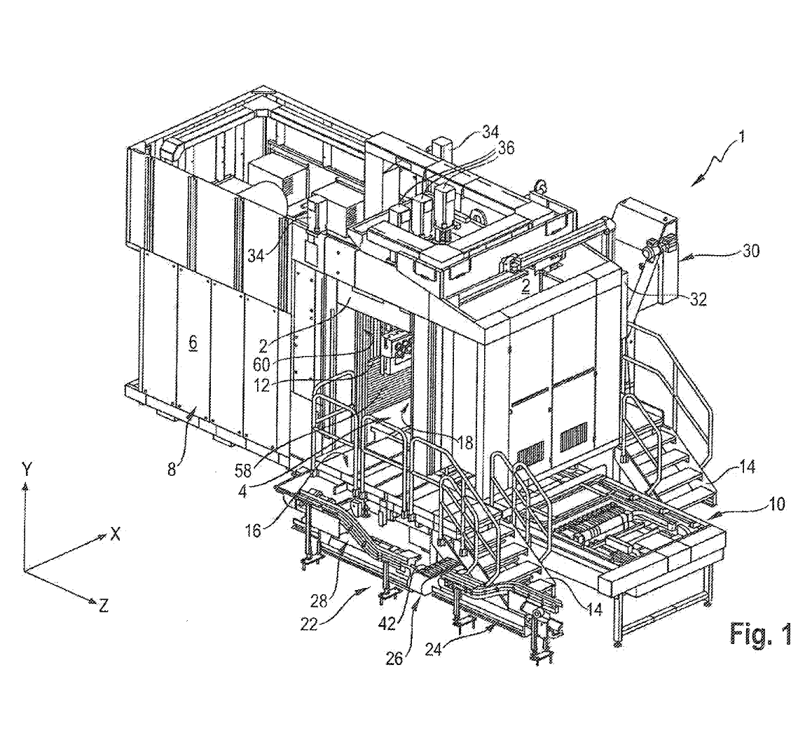

FIG. 1 shows the embodiment of a machine tool 1 according to the invention for a general survey in a first isometric overall view. The machine tool 1 comprises a frame 2 by which a working space 4 is delimited. By means of the frame between the profiles of the frame 2 functional compartments are formed for flexibly fulfilling different functions: access, support of workpiece carrier, tool carriers, tool spindle, workpiece supply and discharge and others. A major part of the machine tool 1 is cladded by lining elements 6. By means of the lining elements 6 side walls 8 of the machine tool I are formed. The machine tool I further includes a workpiece carrier inserting means 10 by which workpieces, in this case connecting rods 42 to be machined, can be loaded to and unloaded from a workpiece carrier 12 arranged in the working space 4 through a functional compartment of the frame 2. For a more detailed disclosure and description of the configuration. the functioning and the advantages of the workpiece carrier inserting means 10. applicant's German patent application with the file number 10 2011 050 959.3 is referred to in this context. The workpiece feeding means (8) described there substantially corresponds to the workpiece carrier inserting means 10 of the present description. The working space 4 is accessible for operators by way of two stairs 14. The stairs 14 lead to a working platform 6. From there two accesses 18 permit access to the working space 4. The two accesses 18 (only one thereof being represented in FIG. 1) can be closed by respective automated roll-up doors 20.

For supplying the workpiece carrier inserting means 10 the machine tool 1 includes a workpiece feeding means 22 comprising a feed conveyor 24, a cross conveyor 26 and a discharge conveyor 28. During operation of the machine tool 1 as specified the operating and inserting staff inserts connecting rods 42 to a conveyor belt of the feed conveyor 24 which conveys the connecting rods 42 to the cross conveyor 26. By appropriate automation and synchronization of the feed conveyor 24 with the cross conveyor 26, the latter is successively loaded with a number of connecting rods 42 as specified.

The machine tool 1 moreover includes a coolant/lubricant supply unit 30 for supplying the tools and workpieces with coolant and lubricant, respectively, during machining. Furthermore, the machine tool includes a control unit 32 by which the operating staff can control the machine tool 1. On the upper side of the machine tool 1 in FIG. 1 supply units of the machine tool 1 are arranged. There are clearly visible five drives of the machine tool 1. The two roll-up doors 20 of the machine tool 1 can be actuated via two drives 34. Tool spindles of a second machining mode (screw-hole machining of the connecting rods, not shown) can be driven via three drives 36.

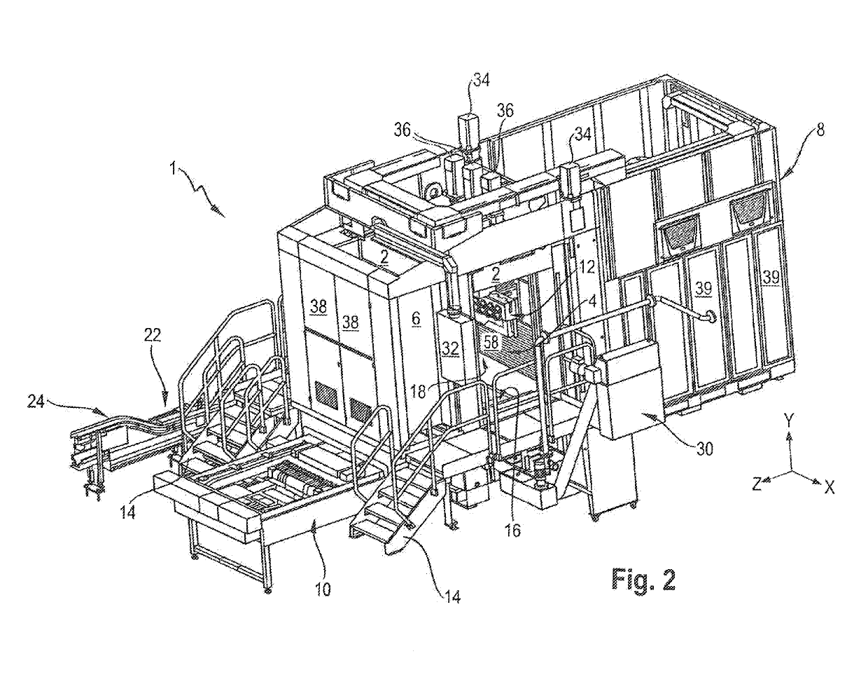

FIG. 2 illustrates the same machine tool I in a similar isometric view, wherein in this case the coolant/lubricant supply unit 30 is facing the viewer and the workpiece feeding means 22 is facing away. Compared to FIG. 1, in the working space 4 of the machine tool 1 the workpiece carrier 12 is more clearly visible. Moreover, the machine tool 1 in FIG. 2 on the left has two doors 38 which enable access to drives of a first machining module (pre-machining of the connecting rods, not shown). On the right in FIG. 2 doors 39 are visible which enable access to said supply units of the machine tool 1.

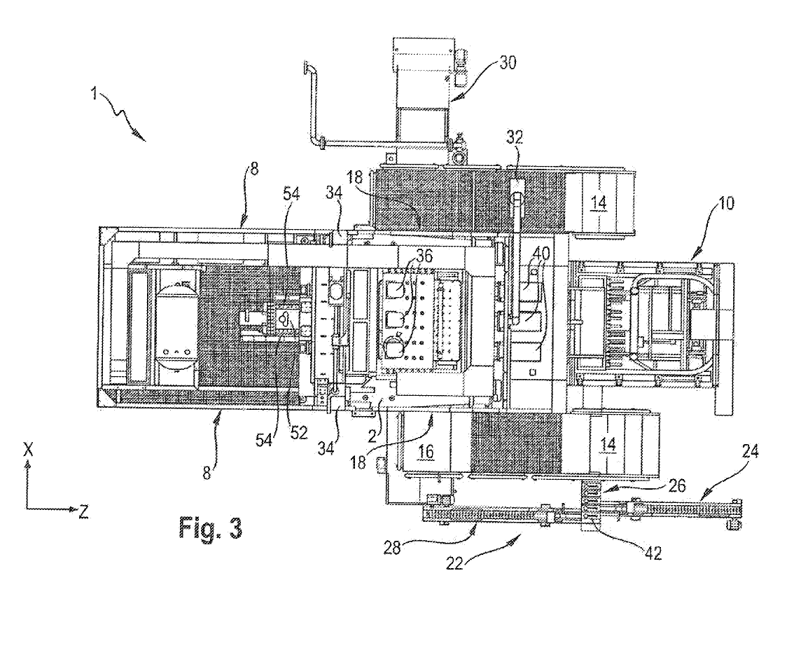

FIG. 3 illustrates the machine tool 1 in a top view, i.e. opposite to the direction of the Y axis. As an additional information compared to the preceding two FIGS. 1 and 2, according to FIG. 3 approximately in the center an arrangement of three drives 40 of the pre-machining of the connecting rods 42 is evident. Via, said drives 40 tool spindles of the pre-machining operation can be driven. Furthermore, it is clearly visible in FIG. 3 that the cross conveyor 26 is loaded with a plurality of connecting rods 42.

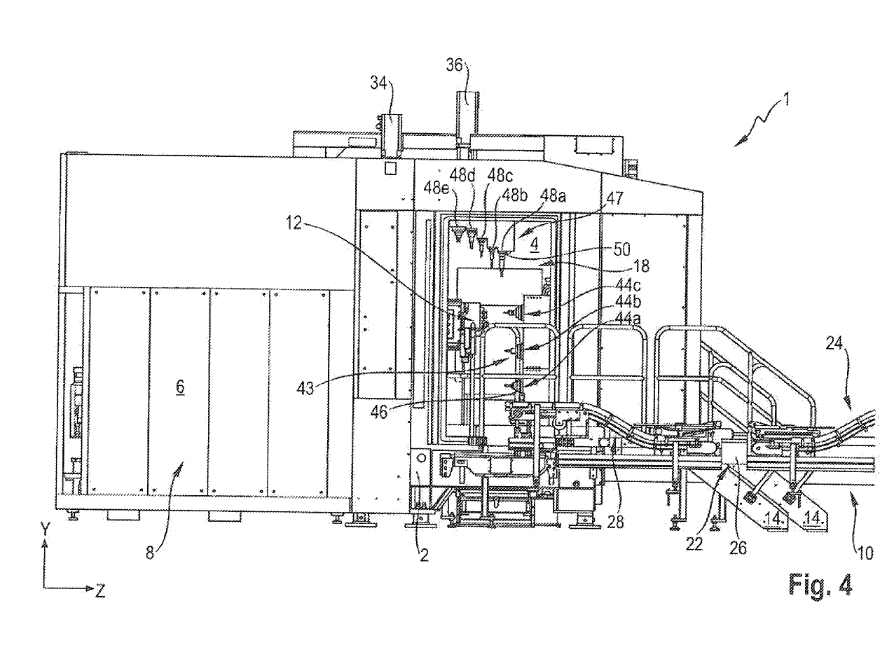

FIG. 4 illustrates a view of the machine tool 1 along the X axis thereof. In FIG. 4 the configuration of the working space 4 can be seen especially clearly. On the left in the working space 4 the workpiece carrier 12 is arranged. On the right in the working space 4 opposite to the workpiece carrier 12, three lines 44a, 44b and 44c of tool spindles 46 of the first machining module 43 for pre-machining of the connecting rods 42 are arranged. The three lines 44a to 44c extend into the viewing plane of FIG. 4 in the direction of the X axis of the machine tool 1. Each line 44a to 44c of the first machining module 43 has six tool spindles 46. Each single line 44a, 44b, 44c corresponds to one single machining step for pre-machining the connecting rods 42.

At the top of the working space 4 five lines 48a to 48e of tool spindles 50 of the second machining module 47 are arranged for screw-hole machining of the connecting rods 42. Also these five lines 48a to 48e include six tool spindles 50 in the direction of the X axis of the machine tool 1. The reference numerals 46 and 50 for the tool spindles of the first machining mode 43 and, respectively, the second machining mode 47 are arranged at a respective one of the spindles for reasons of clarity. The reference numeral 46 denotes a tool spindle of the first machining module 43 or rather of the three lines 44a to 44c of the first machining module 43, even if the tool spindles of the individual lines 44a to 44c are different from each other. This applies mutatis mutandis to the assignment of the reference numeral 50 to the tool spindles of the lines 48a to 48e of the second machining module 47.

In this context, an advantage of the machine tool 1 according to the invention becomes clear. This machine tool does not only permit a simultaneous machining of six workpieces or connecting rods 42, resp., by the corresponding number of tool spindles 46 and 50, resp., in the lines 44a, b, c and 48a through e, but also combines two machine tools and, resp., two machining modules 43 and 47 that have been split to different machines so far (pre-machining and screw-hole machining) in a machine tool. The machine tool 1 according to the invention in this way permits reducing the investment costs.

For better utilization of the space available in the working space 4 the lines 48a to 48c are superimposed, on the one hand, in the direction of the Y axis of the machine tool 1 in offset planes of application and are juxtaposed, on the other hand, in the direction of the Z axis of the machine tool 1 in different planes of application.

By moving the workpiece carrier 12 along the Z axis and the Y axis of the machine tool 1 the tools of one of the lines 44a to 44c or 48a to 48e can be simultaneously engaged in accordance with the invention for performing the appropriate machining step at the six connecting rods. In the shown embodiment, the workpiece carrier 12 sequentially approaches one line after the other 44a . . . 48e in a specified order.

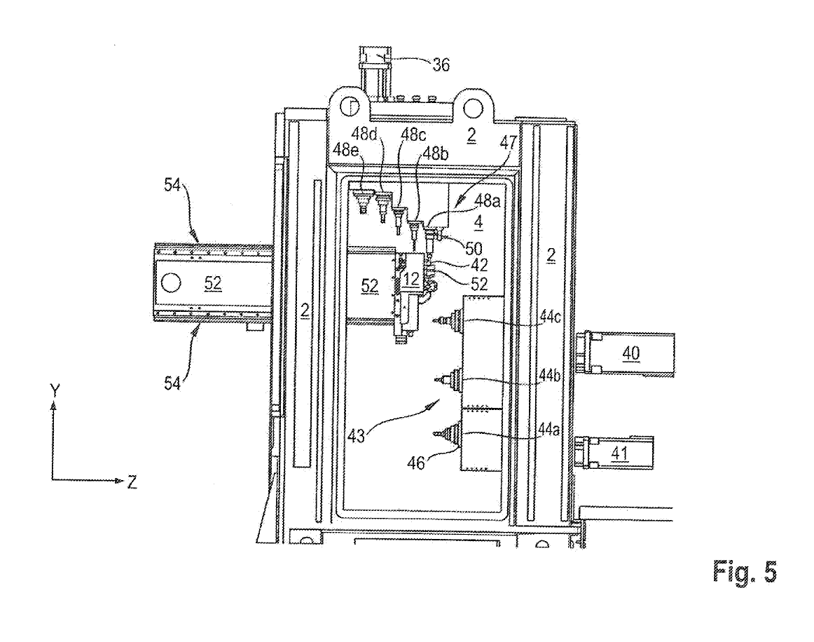

FIG. 5 illustrates the machining of the connecting rods 42 as specified during a machining step carried out over the line 48a. It is clearly visible in this context in which way the connecting rod 42 is fastened to the workpiece carrier 12 via clamping jaws 52. Due to the fact that in the representation according to FIG. 5 all lining parts of the machine tool 1 are removed, it is clearly visible that the frame 2 is formed in an especially massive and rigid manner in particular in the direction of force flux extending substantially along the axes Y and Z. Due to this massive and rigid design especially high manufacturing tolerances of the connecting rod are possible. Furthermore, it is clearly visible in FIG. 5 that the lines 44b and 44c of the first machining module are driven jointly via the three drives 40 (two of them are covered). Separate therefrom, the line 44a of the first machining module 43 is supplied via the three drives 41. In FIG. 5 it is also evident due to the distance of the lining parts of the machine tool 1 that the workpiece carrier 12 is arranged at a sleeve 52 which is movable in the direction of the Z axis of the machine tool 1 via four Z guides 54. The use of said four Z guides 54 permits to move the sleeve 52 at all specified Z coordinates into the working space 4 of the machine tool 1. In the shown embodiment, all lines 44a to 44c and 48a to 48e of the tool spindles 46 and 50 are arranged to be stationary, i.e. they are not capable of moving inside the working space. The relative movement between the connecting rods to be machined and the tools of the spindles 46, 50 is thus performed solely due to the movement of the sleeve 52 in the direction of the Z axis, the Y axis and the X axis of the machine tool 1. This corresponds to a pure concept of the inverse machine tool. Deviating from the shown embodiment it is possible, as a matter of course, that also one or more of the lines 44a, b, c or 48a, b, c, d, e can perform a movement along any one of the axes of the machine tool.

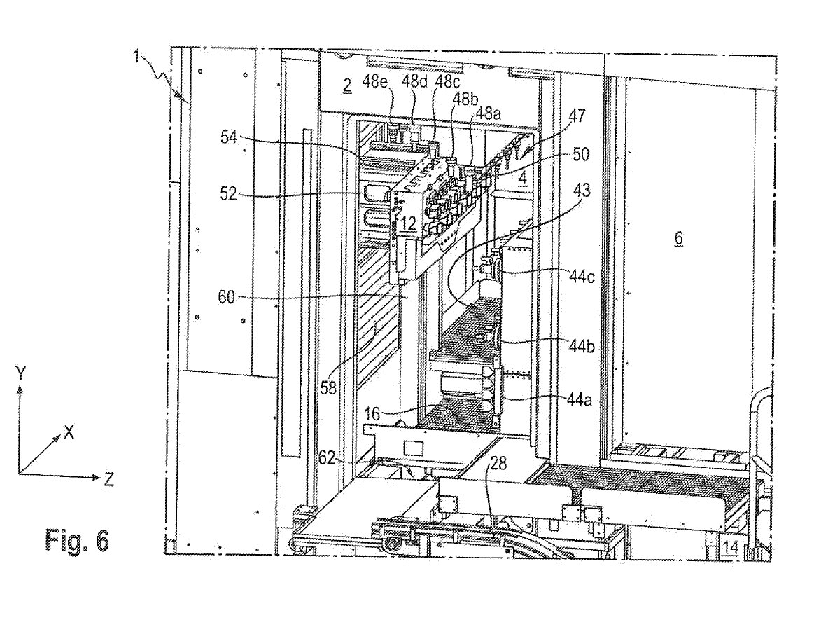

FIG. 6 shows an isometric partial view of the machine tool 1. The partial view is restricted especially to an area of the working space 4. It is clearly visible that the machine tool 1 is provided with a slat cover 58 caught during movement of the workpiece carrier 12 and the sleeve 52, resp., in the direction of the Y axis of the machine tool 1. The movement of the sleeve 52 along the Y axis takes place along a Y guide 60 disposed at the frame 2. Furthermore in a bottom area of the working space 4 FIG. 6 shows a duct 62 by means of which the workpiece carrier 12 can be loaded and unloaded by the carrying member of the workpiece carrier inserting means 10.

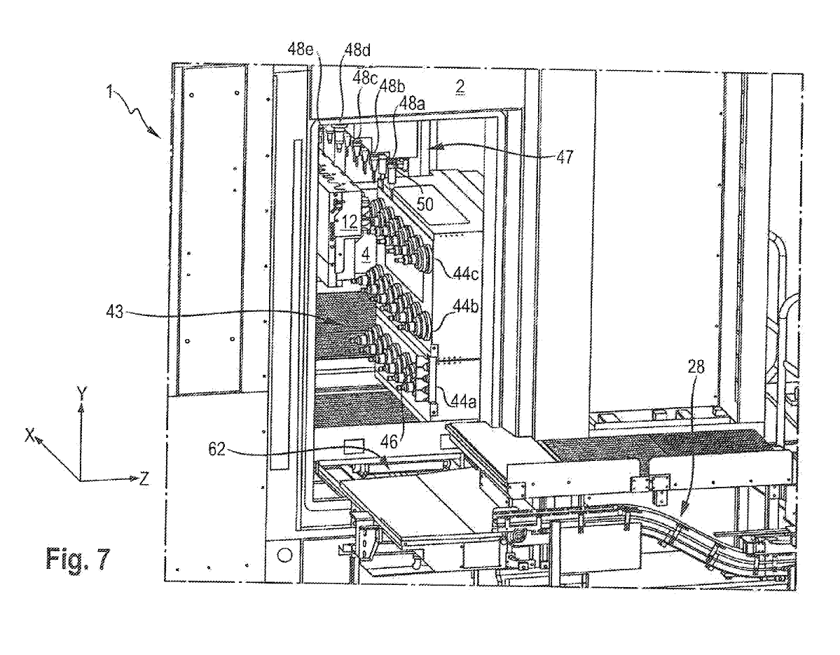

FIG. 7 shows an isometric partial view similar to FIG. 6, but in deviation therefrom with better view of the tool spindles 46 of the first machining module 43. In this case the three lines 44a, 44b, 44c each corresponding to a machining step of the first machining module 43 and the pre-machining of the connecting rods 42, respectively, are clearly evident. When pre-machining the connecting rods 42, by the movement of the sleeve along the Y guide and the Z guide (cf. reference numerals 52, 60, 54 of FIGS. 5, 6, 8, 9 and 10) the workpiece carrier 12 approaches first the line 44a of the first machining step, then the line 44b of the second machining step and after that the line 44c of the third machining step of the first machining module 43. In each machining step all six connecting rods 42 clamped in the workpiece carrier 12 are simultaneously engaged in the six tools of the tool spindles 46 of the respective working step. Each individual tool spindle of a machining step or rather of one of the lines 44a, 44b, 44c is assigned exactly to one connecting rod. Upon completion of the working step 44a the workpiece carrier 12 and the sleeve, resp., moves along the Z guide in FIG. 7 to the left and along the Y guide in FIG. 7 to the top. Hereinafter the second line 44b of the first machining module 43 is approached in that the sleeve moves toward the line 44b along the Z guide in FIG. 7 to the right.

For further machining of the connecting rods 42 the workpiece carrier 12 approaches the lines 44c, 48a, 48b, 48c, 48d and 48e similarly to the afore-described manner along the Z axis and Y axis, resp., of the machine tool 1. Upon completion of all working steps the workpiece carrier 12 returns to its home position, which approximately corresponds to a position according to FIG. 4, and after that is unloaded by the carrying member (not shown) of the workpiece carrier inserting means (cf 10, FIGS. 1 to 4). The carrying member can access the workpiece carrier 12 through the duct 62. When loaded with the finished connecting rods, the carrying member leaves the working space 4 of the machine tool 1 through the duct 62 toward a lower side of the machine tool 1. In so doing, the carrying member performs a combined lowering and pivoting motion along the Y axis and about the X axis of the machine tool so that the carrying member is flatly orientated below the machine tool 1.

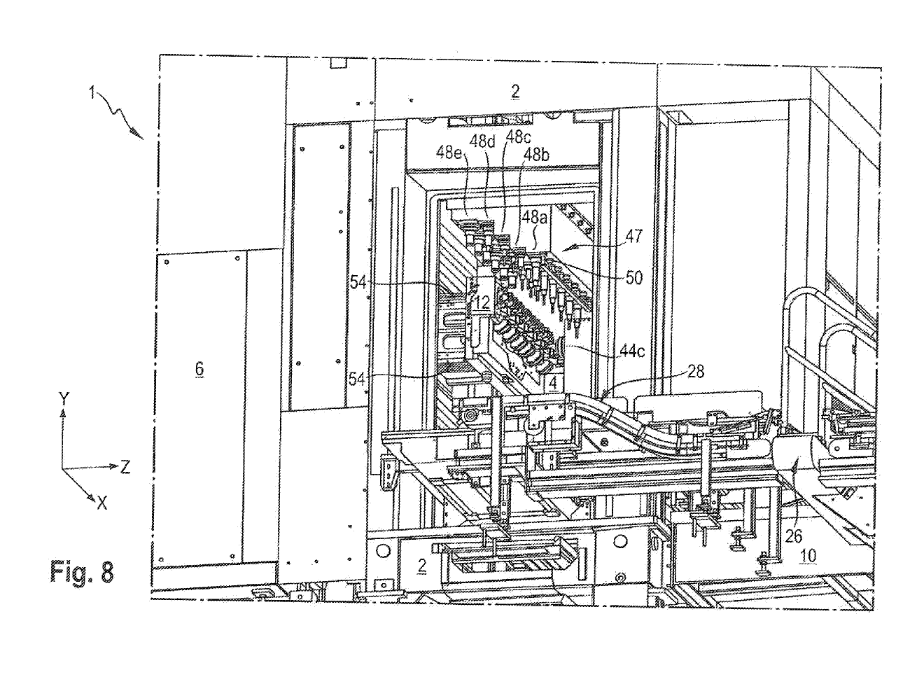

FIG. 8 illustrates an isometric partial view of the machine tool 1 viewed obliquely from the bottom in which at the right bottom a segment of the workpiece carrier inserting means 10 is visible. After the carrying member (not shown) loaded with the connecting rods unloaded by the workpiece carrier 12 has left the working space 4, it moves along the Z axis of the machine tool 1 in FIG. 8 to the right inside the workpiece carrier inserting means 10. Upon reaching the cross conveyor 26 of the workpiece conveying means (cf. 22, FIGS. 1, 2, 3, 4, 6 and 7) the carrying member stops and transfers the six machined connecting rods 42 to the cross conveyor 26. The latter conveys the connecting rods against the X direction of the machine tool 1 shown in FIG. 8 beneath the latter to the outside, where the discharge conveyor 28 takes over the connecting rods and discharges them approximately against the Z direction of the machine tool 1.

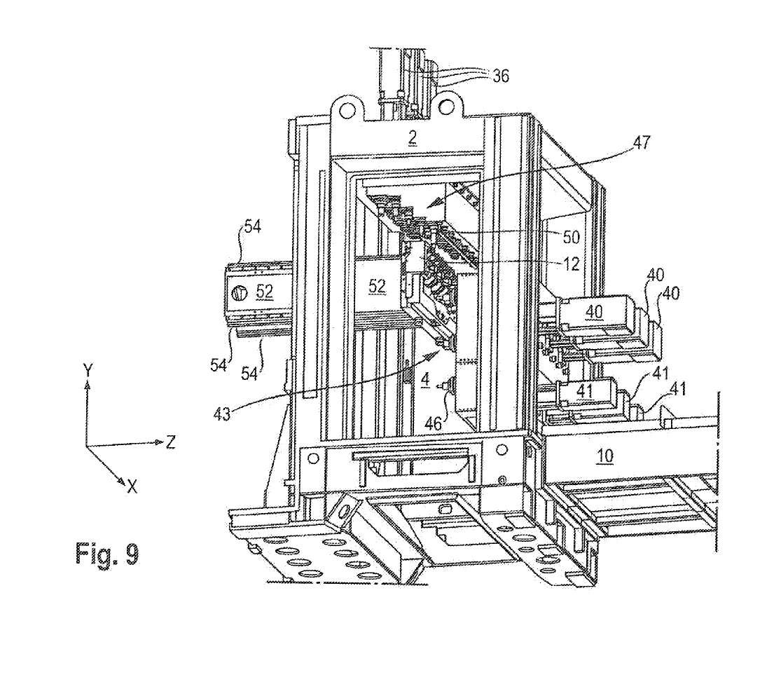

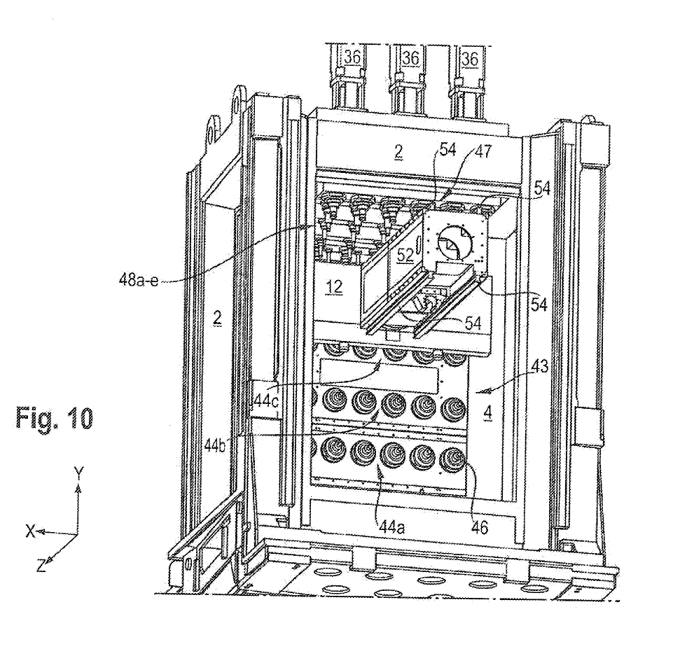

FIGS. 9 and 10 show two further isometric partial views of the working space 4 along with the design of the frame 2 and the drives 36 and, resp., 40 and 41 of the second machining module 47 and the first machining module 43. Moreover, there are shown the sleeve 52 and the workpiece carrier 12 fastened thereto. The two Figures illustrate in particular the robust design and the rigidity of the frame 2 resulting therefrom which is given especially for the main directions of force flux of the Y axis and the Z axis of the machine tool 1. Further, in FIG. 9 a portion of the flat workpiece carrier inserting means 10 is clearly visible by which the carrying member (not shown) is moved, opposite to the Z direction shown in FIG. 9, from the right to the left toward the working space 4.

While, according to the state of the art, for pre-machining of the connecting rods by means of a first machining module and for screw-hole machining of the connecting rods by means of a second machining module a separate machine was necessary for each of the machining modules, the machine tool 1 according to the invention combines these two machining modules 43, 47 in one machine. In order to enable this one machine to provide a similar output of connecting rods, the machine tool 1 according to the invention on the one hand includes the machining modules having at least five, especially six spindles. On the other hand, the workpiece carrier inserting means 10 is formed so that it can be operated at high velocity and exhibits an increase in cycle time vis-à-vis the state of the art of approx. 10%. By combining two machines into one while simultaneously maintaining or even increasing the output, the shown machine tool 1 constitutes an option of reducing the investment costs required for manufacturing connecting rods or workpieces.

Deviating from the shown embodiment, a machining module or a line of the machining module of the machine tool according to the invention can include even more than six tool spindles which simultaneously can be engaged in a respective, one of the workpieces. As a matter of course, it is a precondition that also an appropriate number of workpiece clamping seats is provided at the workpiece carrier.

In addition to the illustrated embodiment, the workpiece carrier of the machine tool according to the invention can be rotatable or pivotal about one or more rotary or pivot axes A, B, C. Said axes A, B, C are preferably arranged approximately in parallel to the axes X, Y, Z of the machine tool.

The invention discloses a machine tool for machining workpieces comprising a frame by means of which a working space is delimited and by which accommodating compartments are formed in which a first machining module and a workpiece carrier are retained, wherein for machining the workpieces predominantly the won piece carrier is movable along at least one guide, in particular an X and/or Y and/or Z guide. In this case the first machining module of the machine tool includes at least five tool spindles which, or rather the tools of which, can be simultaneously engaged in a respective one of the workpieces.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. Machine tool for machining workpieces comprising a frame by means of which a working space is delimited and by which accommodating compartments are formed in which a first machining module and a workpiece carrier are retained, wherein for machining predominantly, the workpiece carrier is movable along at least one guide, including an X or Y or L guide, wherein the first machining module has at least five tool spindles which simultaneously can be engaged in a respective one of the workpieces.

2. The machine tool according to claim 1, wherein the first machining module has at least six tool spindles which simultaneously can be engaged in a respective one of the workpieces.

3. The machine tool according to claim 1, comprising a second machining module having at least five tool spindles which simultaneously can be engaged in a respective one of the workpieces.

4. The machine tool according to claim 3, wherein the at least five or tool spindles of the first machining module and the at least five spindles of the second machining module simultaneously can be engaged in the workpieces.

5. The machine tool according to claim 1, comprising a plurality of machining modules having at least five or tool spindles, wherein the at least five tool spindles of the respective machining operation simultaneously can be engaged in a respective one of the workpieces.

6. The machine tool according to claim 1, wherein the workpieces are connecting rods.

7. The machine tool according to claim 3, wherein the first machining module constitutes a pre-machining operation and the second machining module constitutes a screw-hole machining operation of the connecting rods.

8. The machine tool according to claim 3, wherein the at least five tool spindles of the machining modules are arranged in a line.

9. The machine tool according to claim 1, comprising a workpiece carrier inserting means for loading and unloading the workpiece carrier which includes a carrying member for carrying a plurality of workpieces and which extends approximately in parallel to a lower side of the machine tool.

10. The machine tool according to claim 9, comprising a workpiece conveying means for loading and unloading the carrying member.
